(19) United States
(12) Patent Application Publication
(10) Pub. No.: US 2010/0157338 A1
(43) Pub. Date: Jun. 24, 2010

(54) IMAGE PROCESSING APPARATUS AND IMAGE PROCESSING METHOD

(75) Inventors: Takashi Nakamura, Yokohama-shi (JP); Tetsuya Suwa, Yokohama-shi (JP); Yusuke Hashii, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/633,182

(22) Filed: Dec. 8, 2009

(30) Foreign Application Priority Data
Dec. 22, 2008 (JP) 2008-326588

(51) Int. Cl. H04N 1/60

(52) U.S. Cl. 358/1.9

(57) ABSTRACT

A plurality of patch sets each including a patch formed by an achromatic ink and a patch formed by chromatic inks are formed by changing a combination ratio in first color conversion processing of executing color conversion of image data in correspondence with a first light source and second color conversion processing of executing color conversion of the image data in correspondence with a second light source. The information of a patch set selected by a user from the plurality of patch sets is acquired. The image data is color-converted by the first color conversion processing and the second color conversion processing corresponding to the combination ratio used to form the patch set selected by the user.

### BACKGROUND OF THE INVENTION

1. Field of the Invention

The present invention relates to an image processing apparatus and an image processing method which print an image so as to reproduce a color intended by a user in the observation environment of the user.

2. Description of the Related Art

An image printing apparatus has conventionally been designed in terms of images assuming that a product printed by the apparatus should be observed under a specific light source. For example, CIE (Commission Internationale de l'Eclairage) defines supplementary standard illuminants as standard observation light sources for a reflective manuscript that is a printed product. This recommends observing a reflective manuscript as a printed product under a D50 light source having a correlated color temperature of 5,000 K (Kelvin). Hence, the image printing apparatus is designed, concerning colors, to implement most preferable color reproduction under the D50 light source.

However, the actual use environment of a user cannot be decided uniquely. For example, sunlight and fluorescent light may coexist in an environment. Under such an environment, it may be impossible to implement color reproduction intended under the D50 environment. The reason will be described below.

A color to which an observer reacts upon observing a document is decided by the wavelength of light that irradiates the reflective manuscript. For example, sunlight has an almost continuous intensity from the short wavelength side to the long wavelength side of visible light. On the other hand, artificial lighting can hardly attain such wavelengths. White light can be created artificially by mixing light sources each having its peak at a specific wavelength in the visible light range. This artificial white light often has discontinuous intensity peaks, unlike sunlight.

The spectral reflectance of a reflective manuscript is decided by the spectral reflectance characteristic of a printing medium such as paper or plastic and that of ink such as a dye or a pigment. Reflected light obtained by irradiating such a reflective manuscript with white light such as natural light having a continuous spectral distribution and reflected light obtained by irradiating the document with artificial white light having a discontinuous spectral distribution exhibit different characteristics. As a result, the color appearance changes.

Assuming such a circumstance, for example, Japanese Patent Laid-Open Nos. 2007-281620, 2007-166402, and 2003-250055 have been proposed. These methods allow reproducing a color intended by a designer as much as possible even in the user's observation environment.

Japanese Patent Laid-Open No. 2007-281620 describes a color correction means which considers white adaptation using a color appearance model. However, the model does not necessarily coincide with the use environment of each user. Additionally, a user cannot always appropriately set his/her observation environment.

Japanese Patent Laid-Open No. 2007-166402 describes a color correction means which enables a user to designate an arbitrary light source. However, it is not suitable for general users because a user needs to grasp his/her observation environment.

Japanese Patent Laid-Open No. 2003-250055 describes a color conversion means which considers acquiring the constituent ratio of observation light sources. To do this, the apparatus needs to have an arrangement for measuring the light source in the observation environment, resulting in an increase in cost.

### SUMMARY OF THE INVENTION

The present invention provides an image processing apparatus and an image processing method which can perform color reproduction according to a light source in a printing environment with a simple arrangement.

The present invention in its first aspect provides an image processing method of processing image data to be used by an image forming apparatus for forming an image using ink, comprising the steps of forming a plurality of patch sets each including a patch formed by an achromatic ink and a patch formed by chromatic inks by changing a combination ratio in processing that combines first color conversion processing of executing color conversion of the image data in correspondence with a first light source and second color conversion processing of executing color conversion of the image data in correspondence with a second light source; acquiring information of a patch set selected by a user from the plurality of patch sets; and color-converting the image data by the first color conversion processing and the second color conversion processing corresponding to the combination ratio used to form the patch set selected by the user.

The present invention in its second aspect provides an image processing apparatus for processing image data to be used by an image forming apparatus for forming an image using ink, comprising a controller configured to form a plurality of patch sets each including a patch formed by an achromatic ink and a patch formed by chromatic inks by changing a combination ratio in processing that combines first color conversion processing of executing color conversion of the image data in correspondence with a first light source and second color conversion processing of executing color conversion of the image data in correspondence with a second light source; an acquisition unit configured to acquire information of a patch set selected by a user from the plurality of patch sets; and a conversion unit configured to color-convert the image data by the first color conversion processing and the second color conversion processing corresponding to the combination ratio used to form the patch set selected by the user.

According to the present invention, it is possible to perform color reproduction according to a light source in a printing environment with a simple arrangement.

Further features of the present invention will become apparent from the following description of exemplary embodiments with reference to the attached drawings.

### BRIEF DESCRIPTION OF THE DRAWINGS

FIG. 1 is a perspective view showing the internal arrangement of an inkjet printing apparatus applicable to the present invention;

FIG. 2 is a schematic view for explaining the array state of orifices of a printhead 11;

FIG. 3 is a block diagram showing an image processing system according to the embodiment;

FIG. 4 is a flowchart illustrating a procedure of image data conversion processing executed by a CPU 102 according to the embodiment;

FIG. 5 is a flowchart illustrating a procedure of image processing including color correction processing according to the embodiment; and

FIG. 6 is a view showing an example of patches printed according to the embodiment.

### DESCRIPTION OF THE EMBODIMENTS

The best mode for carrying out the present invention will now be described in detail with reference to the accompanying drawings. Note that the same reference numerals denote the same constituent elements, and a description thereof will be omitted. In the following embodiment, a printer serving as a printing apparatus using an inkjet printing scheme will be described as an example.

<Inkjet Printing Apparatus>

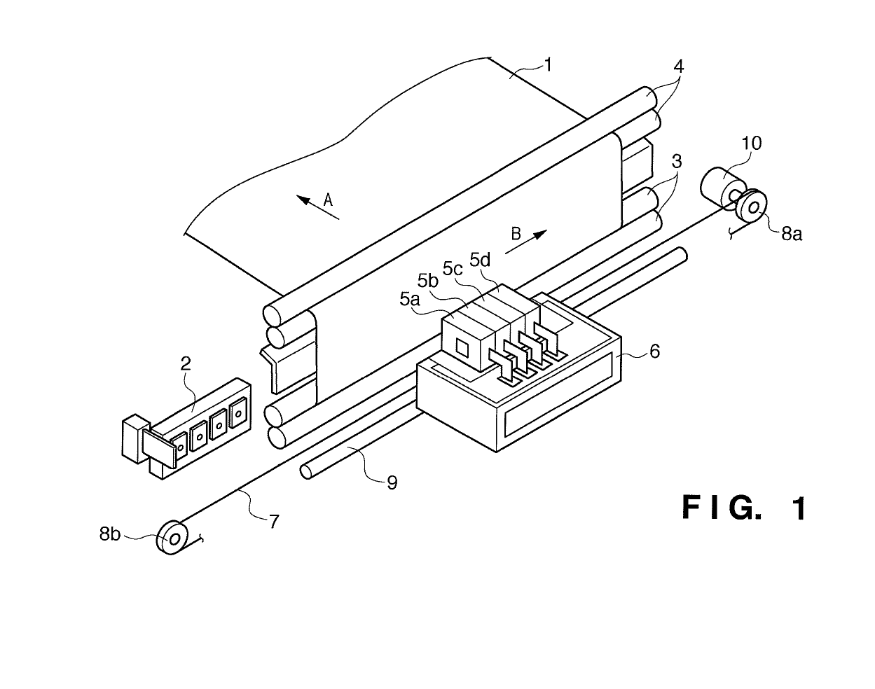

FIG. 1 is a perspective view showing the internal arrangement of an inkjet printing apparatus applicable to the present invention. A printing medium 1 is a paper sheet or a plastic sheet. Before printing, a plurality of printing media 1 are stacked on a cassette (not shown) or the like. When printing starts, a feed roller (not shown) supplies the printing media into the printing apparatus main body one by one. A first conveyance roller pair 3 and a second conveyance roller pair 4 are arranged at a predetermined interval as shown in FIG. 1. Each of the first conveyance roller pair 3 and the second conveyance roller pair 4 is driven by a corresponding stepping motor (not shown) so as to convey the printing medium 1 held in the roller pairs in the direction of an arrow A by a predetermined amount.

Ink tanks 5a to 5d supply inks (color materials) to a printhead 11 of the inkjet printing apparatus. The ink tank 5a stores black (K) ink; the ink tank 5b, cyan ink; the ink tank 5c, magenta ink; and the ink tank 5d, yellow (Y) ink. An orifice surface which discharges ink from the printhead 11 faces the printing medium 1 which is held by the first conveyance roller pair 3 and the second conveyance roller pair 4 so as to have a tensile force to some extent. The printhead 11 for discharging a total of four color inks may have independent units for the respective colors or an integrated arrangement.

The printhead 11 and the ink tanks 5a to 5d are detachably attached to a carriage 6. A carriage motor 10 can reciprocally move the carriage 6 in the direction of an arrow B via two pulleys 8a and 8b and a belt 7. At this time, a guide shaft 9 guides and supports the scan direction of the carriage 6.

A recovery unit 2 performs maintenance processing of the printhead 11. The printhead 11 moves to the home position, as needed, where the recovery unit 2 is provided. The recovery unit 2 performs recovery processing of, for example, solving clogging in the orifices of the printhead 11.

To print, the carriage 6 moves in the direction of the arrow B at a predetermined speed. The printhead 11 discharges an ink droplet at an appropriate timing in accordance with image data. When the printhead 11 has ended print scanning of one cycle, the conveyance roller pairs 3 and 4 convey the printing medium 1 in the direction of the arrow A by a predetermined amount. Such print scanning and printing medium conveyance are alternately performed, thereby sequentially forming an image on the printing medium 1. Note that the direction of the arrow A, that is, the printing medium conveyance direction is perpendicular to the direction of the arrow B, that is, the head scanning direction.

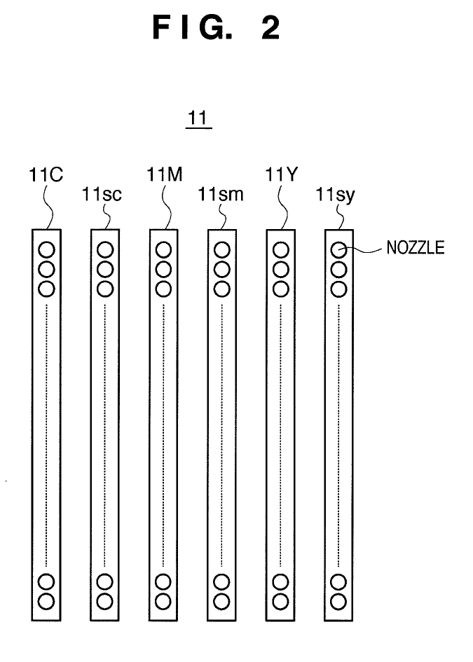

FIG. 2 is a schematic view for explaining the array state of orifices of the printhead 11. The orifice arrays of the respective colors are arranged as shown in FIG. 2 in the same order (KCMY) as the ink tanks 5a to 5d in the direction of the arrow B, that is, the carriage scanning direction. FIG. 2 does not illustrate a black orifice array which discharges black ink supplied from the ink tank 5a. A large cyan ink orifice array 11C which discharges large droplets of cyan ink supplied from the ink tank 5b and a small cyan ink orifice array 11C which discharges small droplets of cyan ink are arranged on the right side of the black ink orifice array (not shown). A large magenta ink orifice array 11M which discharges large droplets of magenta ink supplied from the ink tank 5c and a small magenta ink orifice array 11sm which discharges small droplets of magenta ink are arranged on the right side of the small cyan ink orifice array 11sc.

A large yellow ink orifice array 11Y which discharges large droplets of yellow ink supplied from the ink tank 5d and a small yellow ink orifice array 11sy which discharges small droplets of yellow ink are arranged on the right side of the small magenta ink orifice array 11sm. Each of the orifice arrays of the respective colors includes 512 orifices which are arranged at a pitch of about 42 μm in almost the same direction as the printing medium conveyance direction. Hence, when the printhead 11 performs print scanning of one cycle, an image having a resolution of, for example, 600 dpi (dots/inch) and a height of about 21.6 mm is formed on the printing medium.

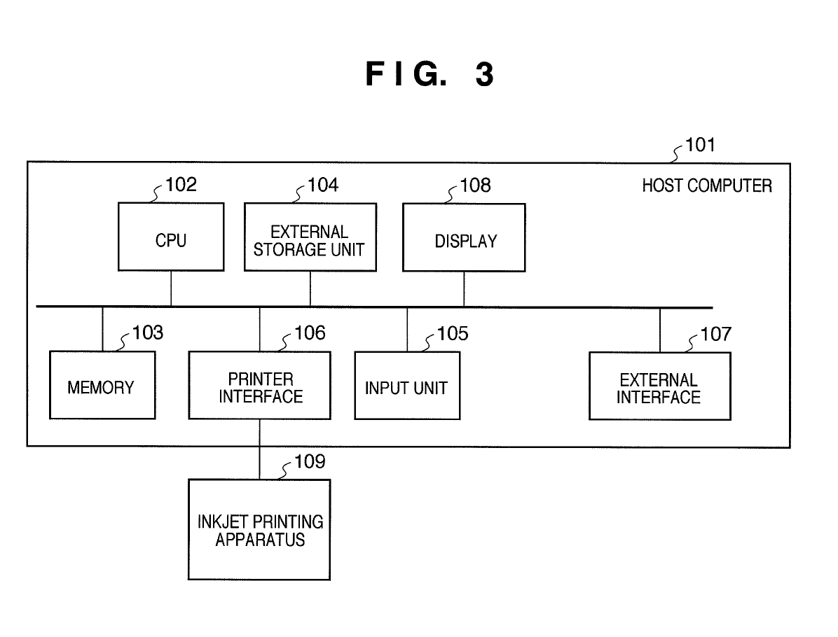

FIG. 3 is a block diagram for explaining an image processing system applied in this embodiment. As shown in FIG. 3, the image processing system includes a host computer 101 and an inkjet printing apparatus 109 shown in FIG. 1.

The host computer 101 includes a CPU 102, memory 103, external storage unit 104, input unit 105, printer interface 106, external interface 107, and display 108.

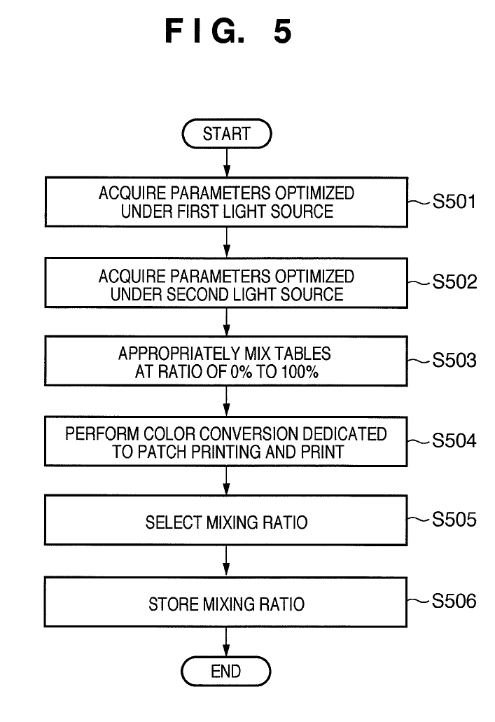

The CPU 102 executes a special program (to be described later with reference to FIG. 5) dedicated to patch printing and a color correction program, which are stored in the external storage unit 104, thereby performing various kinds of image data conversion processing (to be described later) and overall processing associated with printing. The memory 103 serves as a work area for conversion processing or an area to temporarily store image data. Note that the programs to be used to execute image data conversion processing and the like may be supplied from an external storage device (not shown) to the host computer 101 via the external interface 107. The user can input various commands using the input unit 105 while confirming the contents on the display 108.

The host computer 101 is connected to the inkjet printing apparatus 109 via the printer interface 106. The CPU 102 transmits image data which has undergone conversion processing to the inkjet printing apparatus 109 and causes it to execute printing.

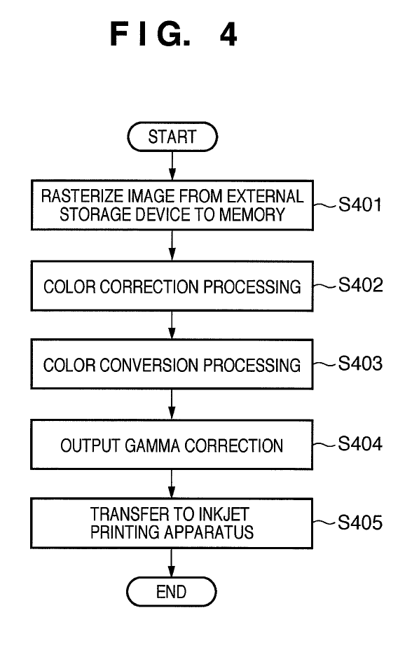

FIG. 4 is a flowchart illustrating a procedure of image print processing executed by the CPU 102 of the host computer according to this embodiment. First in step S401, image data represented by red (R), green (G), and blue (B) luminance signals each containing eight bits (256 tones) is rasterized from the external storage unit 104 to the memory 103.

In step S402, the CPU executes color correction processing of generating a lookup table to obtain a designer's intended color under an observation environment. This processing will be explained later.

In the color correction processing in step S402, three-dimensional RGB signals are converted into identical three-dimensional RGB signals. This conversion processing is done by conversion processing using a matrix or color conversion processing using a three-dimensional color conversion processing lookup table (LUT).

In step S403, the RGB signals are converted into C, M, Y, SC, SM, SY, and K density signals. A three-dimensional lookup table is used here as well. More specifically, the CPU 102 obtains density signal values expressed by C, M, Y, SC, SM, SY, and K corresponding to the combination of the input RGB signal values by referring to the lookup table.

The lookup table holds only density signals corresponding to specific discrete RGB signals and may therefore be unable to cope with all RGB combinations which are rasterized in step S401 and expressed by 256 tones for each color. Hence, in step S403, RGB signals in a color region that is not held in the LUT are obtained by interpolation processing using a plurality of held data. The interpolation processing method executed here is a known technique, and a detailed description thereof will be omitted.

The density signal values acquired by the color conversion processing in step S403 are output as density data having 256 tone values expressed by eight bits, like the luminance signal values, for example, the input values. More specifically, 8-bit RGB data are converted into 8-bit cyan (C), magenta (M), yellow (Y), small cyan (SC), small magenta (SM), small yellow (SY), and black (K) data.

Next in step S404, output gamma correction is performed to correct each ink color so that the optical densities to be finally expressed on the printing medium have a linearity with respect to the input density signals. In this embodiment, a one-dimensional lookup table independently prepared for each color is referred to. The output signal from the output gamma correction is 8-bit density data like the input values. In step S405, the density signals that have undergone the output gamma correction are transmitted to the inkjet printing apparatus 109.

The procedure of color correction processing in step S402 will be described below. Note that in this embodiment, the lookup table to be described below is not always generated in the flowchart shown in FIG. 4. For example, in the first processing of the flowchart in FIG. 4, a lookup table to obtain a designer's intended color under an observation environment is generated and stored in a storage area or the like. In image print processing of the second and subsequent times, the lookup table is not generated in step S402. Color conversion processing is executed using the already stored lookup table.

FIG. 5 is a flowchart illustrating a procedure of color correction processing according to the embodiment. The difference in appearance by ambient light changes depending on the constituent ratio of inks printed on a printing medium such as paper.

In this embodiment, the CPU acquires parameters optimized under a first light source and a second light source, which are different from each other and serve as references. More specifically, for example, a lookup table for D50 is prepared in advance, which makes black of a single black ink (black: achromatic color material K) equal to mixed black (i.e., process black: to be referred to as “PK” hereinafter) by C, M, and Y chromatic color materials under a D50 reference light source. The lookup table for D50 (the lookup table optimized under the D50 light source) will be referred to as a “LUT-D50” or “reference lookup table” hereinafter.

In addition, for example, a lookup table for F10 (optimized under an F10 light source) (to be referred to as an “LUT-F10” or “reference lookup table” hereinafter) is prepared in advance, which makes K equal to PK under an F10 reference light source. D50 is the first light source, and F10 is the second light source.

The above-described lookup tables are prepared in the external storage unit 104 in advance and read out to the memory 103 in steps S501 and S502, thereby acquiring the parameters of the reference lookup tables.

In step S503, a plurality of new lookup tables are generated by mixing (combining) the “LUT-D50” and “LUT-F10” at an arbitrary ratio. The mixing will be explained here. As is known, a lookup table is formed by arranging color conversion definitions corresponding to predetermined lattice points in the form of a table. Hence, to mix two lookup tables, they may have elements in the same number. The lookup tables can be mixed at an arbitrary ratio by combining, for each element of the lookup tables, corresponding signal values in the two lookup tables at the arbitrary ratio. This also applies to a conversion matrix for color correction and so-called matrix operation, and mixing can be implemented by combining two mixing target matrix elements at an arbitrary ratio. In this embodiment, a case will be described in which, for example, five lookup tables are generated.

A lookup table, that is, “LUT-D50” is generated by setting the mixing ratio of “LUT-F10” to “LUT-D50” at 0%. A lookup table “LUT-25” is generated by setting the mixing ratio of “LUT-F10” to “LUT-D50” at 25%. A lookup table “LUT-50” is generated by setting the mixing ratio of “LUT-F10” to “LUT-D50” at 50%. A lookup table “LUT-75” is generated by setting the mixing ratio of “LUT-F10” to “LUT-D50” at 75%. A lookup table, that is, “LUT-F10” is generated by setting the mixing ratio of “LUT-F10” to “LUT-D50” at 100%.

In the process of step S503, for example, the user may set the mixing ratio while referring to a user interface displayed on the display 108 so as to input a desired number of lookup tables via the input unit 105.

Next in step S504, patch sets corresponding to the plurality of lookup tables generated in step S503 are generated. The same processes as in steps S403 to S405 are performed temporarily to print patches corresponding to the patch data.

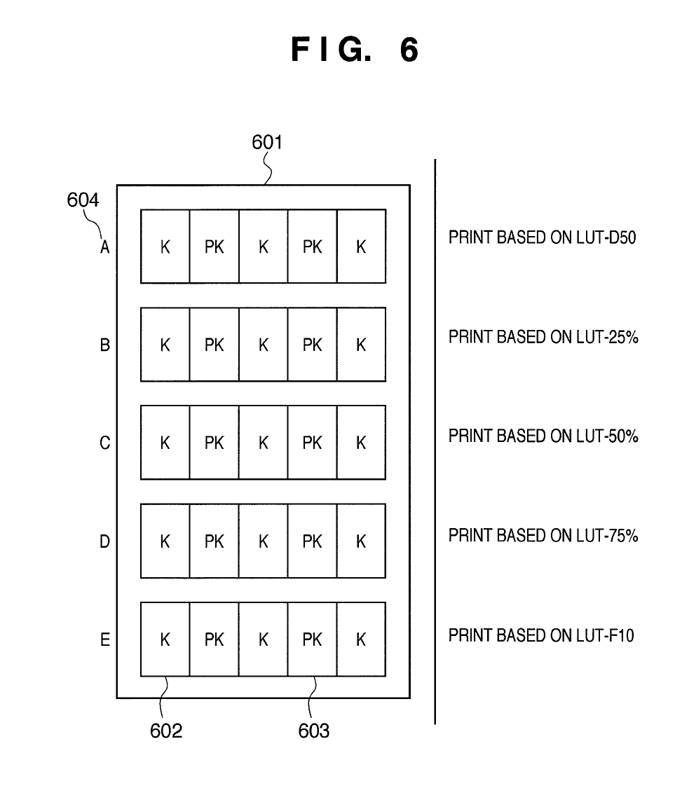

The patch sets printed in step S504 will be described here with reference to FIG. 6. FIG. 6 is a view showing the patch sets printed according to the embodiment. In patches 601 shown in FIG. 6, a K region 602 that is a region to be printed using K and a PK region 603 that is a region to be printed using PK are alternately printed. Identifiers 604 (A to E) are symbols to identify the patches.

In step S504, the same process as the color conversion processing S403 in FIG. 4 is performed for the lookup tables generated in step S503 while alternately arranging the K region 602 and the PK region 603, thereby generating the data of the patches 601.

The generated data of the patches 601 is transmitted to the inkjet printing apparatus 109 by the same processes as in steps S404 and S405. As a result, the patches are printed.

Referring back to FIG. 5, in step S505, the user looks at the printed patches 601 and selects a patch set visually including a minimum difference between K and PK. Consequently, the lookup table mixing ratio (contribution ratio) preferable for ambient light in the observation environment is decided.

In step S506, the host computer 101 receives the thus selected mixing ratio (identifier 604) and stores it in a storage area. For example, the user may input the identifier 604 of the selected patch set on the inkjet printing apparatus 109 and transmit the result to the host computer 101. Alternatively, the user may input the identifier via a user interface displayed on the display 108 by the input unit 105.

When the lookup table mixing ratio has been decided, it is possible to decide an optimum lookup table conforming to the user's observation environment from the plurality of lookup tables generated in step S503.

After executing the color correction processing in step S402 of FIG. 4, the decided lookup table is used in the process from step S403. From then on, the lookup table decided in the above-described way can also be used in print processing of another image.

As described above, in this embodiment, it is possible to perform color reproduction of a printed product optimum for a user's observation environment as desired by the user.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-326588, filed Dec. 22, 2008, which is hereby incorporated by reference herein in its entirety.

What is claimed is:

1. An image processing method of processing image data to be used by an image forming apparatus for forming an image using ink, comprising the steps of:
forming a plurality of patch sets each including a patch formed by an achromatic ink and a patch formed by chromatic inks by changing a combination ratio in processing that combines first color conversion processing of executing color conversion of the image data in correspondence with a first light source and second color conversion processing of executing color conversion of the image data in correspondence with a second light source;
acquiring information of a patch set selected by a user from the plurality of patch sets; and
color-converting the image data by the first color conversion processing and the second color conversion processing corresponding to the combination ratio used to form the patch set selected by the user.

2. The method according to claim 1, wherein in the forming step, a black patch formed by the achromatic ink and a black patch formed by the chromatic inks are formed.

3. The method according to claim 1, wherein in the forming step, the plurality of patch sets are formed by changing a ratio of combining a signal value obtained by the first color conversion processing with a signal value obtained by the second color conversion processing.

4. The method according to claim 1, wherein in the forming step, the plurality of patch sets are formed by adjacently arranging the patch formed by the achromatic ink and the patch formed by the chromatic inks.

5. An image processing apparatus for processing image data to be used by an image forming apparatus for forming an image using ink, comprising:
a controller configured to form a plurality of patch sets each including a patch formed by an achromatic ink and a patch formed by chromatic inks by changing a combination ratio in processing that combines first color conversion processing of executing color conversion of the image data in correspondence with a first light source and second color conversion processing of executing color conversion of the image data in correspondence with a second light source;
an acquisition unit configured to acquire information of a patch set selected by a user from the plurality of patch sets; and
a conversion unit configured to color-convert the image data by the first color conversion processing and the second color conversion processing corresponding to the combination ratio used to form the patch set selected by the user.
